(19) United States
(12) Patent Application Publication
(10) Pub. No.: US 2007/0140235 A1
(43) Pub. Date: Jun. 21, 2007

(54) Network visible inter-logical router links

(75) Inventors: Can Aysan, Kanata (CA); Matthew Yuen, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: Nortel Networks Limited, St. Laurent (CA)

(21) Appl. No.: 11/312,386

(22) Filed: Dec. 21, 2005

(51) Int. Cl. H04L 12/56; H04L 12/66

(52) U.S. Cl. 370/389; 370/463

(57) ABSTRACT

A scheme for allowing logical routers to achieve data path efficiency and still maintain network visible virtual links is provided by allowing logical routers in the same physical router to share routing information using standard protocols in place of proprietary route leaking, and by analyzing received data packets to determine if they are tandem data packets or terminating data packets. Tandem data packets are routed directly to egress ports with a single pass through the switch fabric to achieve efficiency, while the TTL value of the packet is decremented twice to maintain the external appearance of the separation of the logical routers. Terminating data packets are routed to other logical routers over virtual links to allow network visibility of the inter-logical router links.

### FIELD OF THE INVENTION

The present invention relates generally to routing of data packets. More particularly, the present invention relates to creating externally visible links between a plurality of logical routers in a single physical router.

### BACKGROUND OF THE INVENTION

In communication networks, packet data is typically transmitted between two nodes by passing the packet through intermediate nodes. In complex data networks, different segments of the network may rely upon different types of connection, leading to heterogeneous networks where asynchronous transfer mode (ATM), Synchronous Optical Network (SONET), frame relay, Ethernet and other networking technologies and media types co-exist.

For data packets to be passed through the networks, routers are typically used to forward the data from one segment to another. The router typically examines the packet header and based on the destination address, determines the port on which the data packet should be put to get to its destination.

Large service providers, such as telecom carriers, typically offer a plurality of service offerings associated with different networks. In many cases different groups manage these services with different policies. This model is often a legacy hold over from the different groups being from different companies. Under this model, each of the services is managed by having a single provider router connecting a series of edge routers to a core network. A particular service, such as Voice over Internet Protocol (VoIP), Virtual Private Network (VPN) data access, or general Internet connectivity, is provided by network 50 as illustrated in FIG. 1. Edge routers (PE) 52 connect to customer networks through each of the plurality of ports 54. Data received from the customer networks on ports 54 is examined by router 52, which then makes a series of prioritization and other administrative decisions on the basis of the data packet header information and the predetermined administration policies. If a packet received at PE 52 is destined for the Core A network 64, PE 52 places it on port P 56 which connects PE 52 to provider router (P) 58. P 58 receives the data packet on port 1 60 which connects P 58 to PE 52 through port P 56. P 58 then places the data packet on port A 62 for transmission to the core network 64.

Edge router P 52 receives less traffic than P router 58, which serves to aggregate traffic from a plurality of edge routers. However, PE 52 performs more administrative functions, such as checking the data format and prioritizing data on the basis of Quality of Service instructions that are more processor intensive. P router 58 is designed to handle large volumes of data traffic being routed through, but is not typically used for the administrative functions.

Different services typically have been offered on different network infrastructure. This has allowed different administrative policies to be employed on PE routers for different services.

The evolution of data service integration has lead to a common network core shared among the disparate services. Edge routers associated with different services, and having different administration policies, connect to a common P router that serves as a connection point to the common core network. In operation the PE routers for different services do not need to recognize that the core network is shared with other services, allowing all the administrative and operation management policies and tools to be maintained.

A network 66 of this type is illustrated in FIG. 2. Three different PE routers, PE-A 68, PE-B 74 and PE-C 80, are illustrated. Each of the PE routers can correspond to different services, although in various implementations, a plurality of routers may be used to provide the same service. Data is received on ports 70 76 and 82 by PE routers PE-a 68, PE-B 74 and PE-C 80 respectively. Each router then makes the prioritization and administration decisions for the received data packets, and if they are destined for an address reachable through the common core 96, the packet is put on Port AP 72, Port BP 74 or Port CP 84 respectively. P router 86 receives the data from the PE routers on Port PA 88, Port PB 90 and Port PC 92. This data packet is routed by P 86 purely based on the destination address, as administrative functions were performed at the edge router. All data destined for the common core 96 are placed on port Pcommon 94, and then transmitted to common core network 96.

The use of a common core allows a limited degree of convergence, which provides the carrier with cost savings by reducing the number of core routers required, and by removing the need for maintaining a series of core networks. The use of a common core to serve all services is frequently used in current networks. By having PE routers dedicated to the different individual services, the operations administration and management (OAM) routines can be maintained, as can the administrative policies that may differ between the different services. Problems arise in this configuration in that small and medium scale service providers may not generate sufficient traffic to fully utilize the plurality of PE routers and the P router. More frequently, the sum of the traffic from the different services and that handled by the P router is equivalent to that that can be handled by a single physical router. This inefficiency results in higher equipment and maintenance costs for service providers, which results in either higher cost to the customer or lower profit.

In furthering the convergence, there has been a push towards the use of a single router to replace the plurality of edge routers and the core router. It is desirable for these solutions to provide an efficient internal datapath while still maintaining the ability to use existing OAM tools.

It is, therefore, desirable to provide a method and system for logical router linking that provides path efficiencies while maintaining the network architecture from the perspective of the existing OAM tools without increasing the number of points of failure.

### SUMMARY OF THE INVENTION

It is an object of the present invention to obviate or mitigate at least one disadvantage of previous integrated edge and provider routing systems.

Routers of the prior art did not provide route efficient data packet handling with externally visible inter-logical links. To address this problem a physical router is provided that hosts logical routers which can access egress ports associated with other logical routers in the same physical router. Data packets passing through the router are analyzed to determine if they are forwarding type data packets or processing based data packets. Forwarding type data packets require simple forwarding and do not require router processing, and so they can be passed in a path efficient manner to the egress port. The packet is modified so that external systems still see it as having traversed a network of routers. If the packet requires processing by one of the logical routers, it is passed between the logical routers using virtual links created in the switch fabric. This reduces the number of external ports used, provides route efficiency for the vast majority of packets, and provides the packets that must interact with one of the logical routers a path between the logical routers that is visible and can be treated like true links. In this manner existing OAM tools can be used without modification, and administrative functions like link cost assignment, route peering and other such functions continue operating as before. This allows a series of physical routers to be replaced without requiring the network topology to be redefined and without incorporating proprietary protocols into the OAM tools to administer policies with each of the logical routers.

In a first aspect of the present invention, there is provided a method of routing a data packet, having header and payload information, received at a physical router having a plurality of logical routers. The method comprises receiving the data packet at a first logical router; and directly routing the data packet to an egress port and modifying the packet to indicate traversal of a logical router network, if the packet is a forwarding type data packet.

In embodiments of the first aspect of the present invention, the step of determining a packet type associated with the data packet to be one of a forwarding type or a processing type precedes the step of directly routing, and the step of forwarding the data packet to a second logical router over a virtual link and modifying the packet to indicate the traversal of the virtual link if the packet is a processing type data packet is also included. In further embodiments, the step of determining the packet type includes examining at least one of a packet destination address and a packet protocol. In other embodiments the step of directly routing the packet to an egress port and modifying the packet includes modifying the header of the data packet to indicate traversal of the logical router network. The modification of the packet can include modifying the header of the data packet to indicate traversal of the virtual link or modifying the payload of the data packet to indicate properties associated with the virtual link. In another embodiment, the step of modifying the header information includes decrementing a time to live value in accordance with a destination address associated with the data packet. In another embodiment the step of routing the data packet to an egress port includes selecting one of a plurality of ports in accordance with a destination address associated with the data packet. In a further embodiment, the method includes receiving, at the first logical router, an address range associated with an egress port over a virtual link from the second logical router in advance of the step of receiving the data packet and updating a local routing table in accordance with the received address range and associated egress port.

In a second aspect of the present invention, there is provided a router for receiving a data packet on at least one of a plurality of ports and for forwarding the received data packet to another destination on another of the plurality of ports in accordance with a destination address associated with the data packet. The router comprises first and second logical routers connected to a switching fabric, each logical router associated with at least one port. The first logical router receives a data packet arriving on a first of the plurality of ports, determines whether the received data packet is a forwarding type data packet or a processing type data packet, and routes the data packet to one of the second logical router and one of the plurality of ports not associated with the first logical router in accordance with the determined packet type. The second logical router receives, on its at least one associated port, routing information for a range of network addresses, creates a virtual link to the first logical router through the switching fabric, and transmits the routing information for the range of network addresses associated with the at least one associated port to the first logical router over the virtual link.

In embodiments of the second aspect of the present invention, the first logical router includes a routing table updater for updating a locally stored routing table with information provided by the second logical router over the virtual link, means to determine the data packet type based on whether the packet whether the packet requires simple forwarding or requires router processing. The router may also include header modification means for modifying a head associated with the data packet, prior to routing, to indicate traversal of a routing network, and that can decrement a time to live value in the header in accordance with a destination address associated with the data packet. The TTL value may be decremented by 1 if the data packet is a processing type data packet and by 2 if the data packet is a forwarding data packet.

In a third aspect of the present invention, there is provided a physical router having a first logical router for receiving a data packet. The first logical router comprises a packet type determination means, a virtual link creation means, an egress port access means and a data packet forwarder. The packet type determination means determines whether the data packet is a processing type data packet or a forwarding type data packet. The virtual link creation means creates a virtual link between the first logical router and a second logical router when the received data packet is determined to be a processing type data packet. The egress port access means create a link between the first logical router and an egress port not associated with the logical router when the received data packet is determined to be a forwarding type data packet. The data packet forwarder receives the data packet type from the packet type determination means, and instructs either the virtual link creation means or the egress port access means to create a link based on the received data packet type and a destination address associated with the data packet, decrements a time to live value associated with the data packet in accordance with the received data packet type, and forwards the received data packet to a destination over the created link.

In embodiments of the third aspect of the present invention, the logical router is hosted by a processor internal to the physical router on a dedicated service card having at least one data port associated with the hosted logical router.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram illustration of a prior art network architecture;

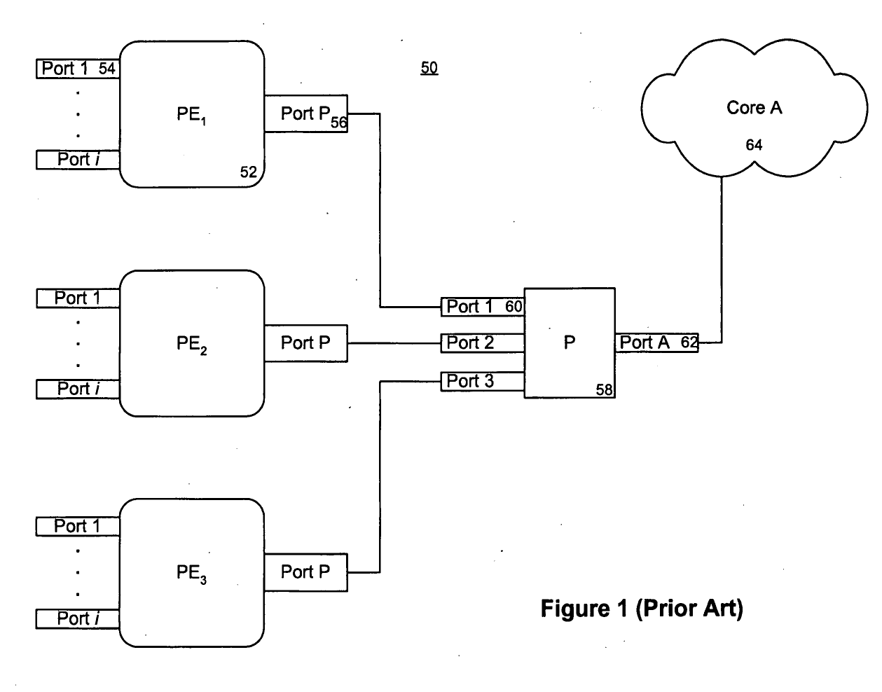

FIG. 2 is a block diagram illustration of a prior art common core network architecture;

FIG. 3 is a block diagram illustration of a common core network architecture making use of a physical router providing a plurality of logical routers;

FIG. 4 is a block diagram illustrating a router providing network visible inter-logical router links;

FIG. 5 is a flow diagram illustrating the handling of tandem data packets;

FIG. 6 is a flow diagram illustrating the handling of terminating data packets; and

FIG. 7 is a flowchart illustrating a method of routing packets using logical routers that provides network visible virtual links.

### DETAILED DESCRIPTION

Generally, the present invention provides a method and system for providing a path efficient routing mechanism that supports existing routing protocols.

As described below, a path efficient router with externally visible inter logical router links can be implemented on routing hardware that supports the creation of logical routers, and preferably provides an interface that supports at least one of Internet Protocol (IP) Multi Protocol Label Switching (MPLS), Intermediate System-to-Intermediate System (ISIS), Open Shortest Path First (OSPF), Border Gateway Protocol (BGP), Routing Information Protocol (RIP) and/or other layer 3 and/or higher protocols. Preferably the system is implemented to provide both 1-to-1 and 1-to-many interconnectivity between logical routers.

To ensure that a packet will not persist indefinitely on the network, packets are often provided with a time-to-live (TTL) value that is decremented by each node that handles the packet. If the TTL value drops to a predetermined threshold value, it is dropped if it fails to reach the destination in a suitable number of hops. An error message is then sent to the originating node to provide failure notification. Network diagnostic tools, such as the ubiquitous trace route utility, make use of the decrementing of the TTL value to aid in the identification of network errors and failures.

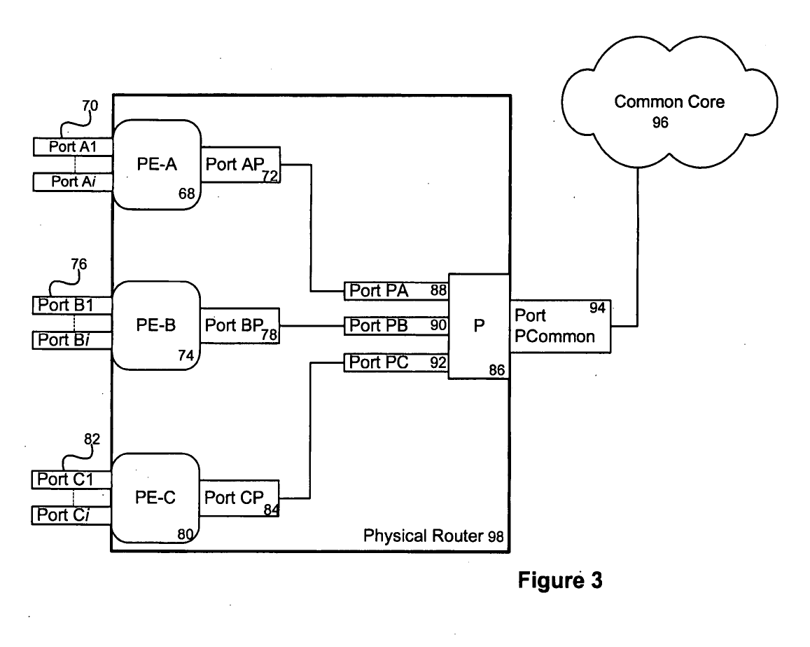

To provide a solution that allows the use of a single device to handle the traffic flow most service providers receive, a single router can be deployed to connect the different customers directly to the common core, with a series of logical routers created in the router to allow the same OAM and administration policies to be used. To ensure that the same logical architecture as the original systems is provided, the logical routers typically are connected to each other to create the same network topology that the OAM tools were designed around. FIG. 3 illustrates such a system.

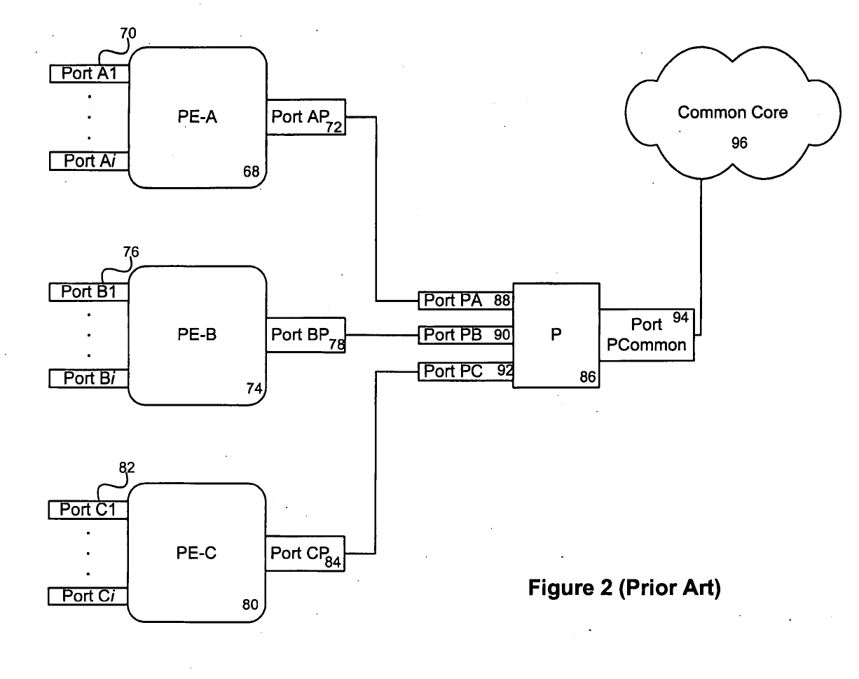

In FIG. 3, network 66 is much the same as that of FIG. 2. However, PE-A 68, PE-B 74, PE-C 80 and P 86 are logical routers created in physical router 98. Ports AP 72, BP 78, CP 84, PA 88, PB 90 and PC 92 are ports that connect the logical routers to each other. As discussed below, there is a plurality of mechanisms for implementing these ports. Ports A1 . . . Ai 70, B1 . . . Bi 76, C1 . . . Ci 82 and PCommon 94 are externally recognized ports that connect the physical router 98 to external networks.

When traffic is received by the physical router 98 on a port that corresponds to Port Al 70, it is routed to the logical instance of router PE-A 68 which handles the administrative functions as before. When the data packet is destined for an address corresponding to the common core 96, it is eventually placed on Port PCommon 94. There are many different mechanisms to provide connections between the logical routers, which will be discussed below.

Before beginning a discussion of how logical routers are commonly interconnected, it should be noted that routers are physical systems. There are a finite number of ports on each router, and commercial routers typically have a number of service card slots that are connected to each other along a backplane that can be treated as a part of the switching fabric. Different network connection types are typically served on different service cards, while each service card provides a number of external ports. Thus, a single unit, with multiple service cards is typically employed, and the different networks are connected to different service cards, although different networks can be connected to the same service card depending on the implementation. Logical routers can be served by a single card, or in the case of a high demand for the logical router, multiple cards can be dedicated to a single logical router. Similarly, a single card may serve as the physical embodiment of a plurality of different logical routers. Thus, a logical router can make use of one or more processors, or may even share a processor with at least one other logical router. It is through the proper allocation of resources that sufficient processor and bandwidth capacity can be allocated to each of the logical routers in the single physical router. Service cards, used for this implementation, are alternatively referred to as forwarder cards, forwarding blades and forwarding engines.

There are four typical configurations of physical routers to support a plurality of logical routers with interconnections between the routers. Each of these configurations provides several advantages, but they also come with corresponding disadvantages, as will be explained below.

The first interconnection technique referred to as hairpin connectivity. The embodiment illustrated in FIG. 3 will be used to explain hairpinning. As noted in the description of FIG. 3, ports A1 . . . Ai 70 are physical ports that would exist as ports accessible on a service card of the physical router 98. Ports AP 72 and PA 88 are ports for internal connectivity between the logical routers. In a hairpin configuration, each router, PE-A 68, PE-B 74, PE-C 80 and P 86, are allocated a number of physical ports. Each of these logical routers assigns one of the allocated physical ports to the internal connectivity ports. Thus, one of the physical ports of router 98 is assigned to Port AP 72, while other physical ports are assigned to ports BP 78, CP 84, PA 88, PB 90 and PC 92. Network cables are used to connect the logical routers to each other. These cables are typically short cables that resemble hairpins. The hairpin configuration allows the logical routers to be connected to each other, and the logical topology closely mirrors that of the previously deployed systems. However, ports are a limited resource in a router, and this unnecessarily consumes ports that could otherwise be used for customer traffic. Additionally, for a packet that is received from a customer network, such as one connected to PE-A 68, and destined for the common core 96, the packet is passed through four different ports. This is an inefficient datapath, and resources are consumed examining the packet both times the packet enters the router. Furthermore, if the router is rated to serve a particular bandwidth, such as 120 Gb/s, the effective data rate is halved, as each packet enters and exits the router twice. This drop in effective bandwidth is costly for the service provider, and is thus undesirable. Furthermore, by involving an external cable, an additional point of failure is introduced. Many service providers and equipment vendors have found that in such configurations, a common failure point is the hairpin connecting cables, which can be kicked, bent, cut or otherwise unintentionally damaged.

To avoid the reliability problems associated with hairpin connectors, a virtual pin or link connector can be used. This virtual pin or link connector can be implemented using forwarding circuitry. Instead of relying upon the connection of externally accessible ports, a virtual pin connector is used to connect two ports that are not made externally accessible. This reduces the opportunity for failure, as the connections are internal to the router chassis. Furthermore, this solution still has the same datapath inefficiencies and resource usage problems as the hairpin solution. As losing 50% of the bandwidth of the router is considered by many to be an unacceptable solution, the use of a virtual pin or link connection does not provide a suitable solution to connecting the virtual routers.

To avoid the excess usage of ports, a dedicated datapath service card can be employed in the router. When a logical router receives data packets that should be forwarded to another logical router, the packets are transferred to a dedicated datapath service card (DSC) installed in one of the router card slots. The DSC then determines which logical router is the next destination and forwards the packet to the appropriate logical router. Although this reduces the port utilization, it results in the requirement for at least one extra slot to be used. The introduction of a new hardware element results in additional probability of failure, as both the physical card hardware, and the software executed by the card are subject to the possibility of failure. Furthermore, the datapath is still not efficient, as a packet received on Port A1 70 destined for Port PCommon 94 is passed from A1 70 to the DSC, which then determines where the packet is to be routed, and then passes the packet to the logical router P 86 to place on Port PCommon 94. This solution is considered suboptimal as it increases the likelihood of failure, does not address the datapath inefficiencies, and is not slot efficient.

Logical routers are, in theory, distinct elements in the physical router 98. However, because each logical router is part of physical router 98, it can be provided with access to all the resources of physical router 98. As a result, if the logical router PE-A 68 has a forwarding information base (FIB) that is updated with all the routing information provided by logical router P 86, it can determine that a packet received on port A1 70 destined for the common core 96 can be placed directly on port PCommon 94. Typically, this is performed by a technique referred to as route leaking. Route leaking allows one logical router to provide its routing table to another logical router using proprietary exchange protocols. This allows logical router PE-A 68 to perform both the administrative functionality of an edge router, and to incorporate the functionality of the P router 86. This leads to an efficient datapath for packets, as they are received on one port, and immediately are placed on the proper output port. This also reduces the probability of failure, as there are no external connections or additional hardware elements that can fail. No additional router slots are consumed, so it is also slot efficient. However, a number of problems are caused by this otherwise efficient solution.

As noted above, a number of OAM tools and routines exist to administer and maintain the policies of the edge routers. These tools are based on certain network topologies that must be externally visible. Leaking routing information between logical routers is commonly performed using proprietary protocols specific to each hardware vendor. Allowing inter-logical router route leaking collapses the functionality of the edge and provider routers, which breaks the OAM policies and tools. Administrative policies such as preventing access to a range of addresses is implemented, if at all, through the use of the proprietary route leaking protocols. For example, a VoIP dedicated edge router may not be permitted to send data to an address range that corresponds to the web servers of commonly used Internet content providers. This may be a security policy implemented by the administration group, but it is not enforceable if the routing tables of router P 86 are leaked to all of the edge routers PE-A 68, PE-B 74 and PE-C 80. Replying upon a proprietary protocol breaks existing OAM tools and thus is not seamless to the service provider. Redesigning the OAM tools for a given proprietary protocol would serve to lock the service provider in to a particular vendor which is infeasible in a network that already make use of different hardware platforms. Furthermore, the path of a packet through the physical router 98 is reduced, which is more efficient, but does not provide the topology that the services have been designed around. Many services make use of administration tools that rely upon the existence of both a PE and a P router. When the functionality of these devices are collapsed to a single device, the utilities, such as trace route, return unexpected results which break the OAM tools deployed to monitor and maintain the network. This is clearly unacceptable to many service providers who want a turnkey solution that can simply be dropped in place of existing hardware to provide a savings, and who do not want to redesign their network architectures to accommodate new hardware functions.

Prior to the discussion of a schemes for providing network visible inter-logical router links, it is important to discuss two different types of network traffic. Data received by a router can be roughly categorized as either forwarding type data or as processing type data. Forwarding data is data received by the router that is destined for an address external to the router and requires nothing more than simple forwarding. Processing data includes packets that must be handled and processed by the router. All data terminating at an address corresponding to a logical router is treated as processing data, as by default, the router must process the data packets. Other types of processing data include packets destined for external addresses having TTL values that will expire prior to exiting the router (e.g. trace route data packets), packets having certain flags set in their headers to indicate the necessity of router processing, packets that require router processing based on either a source or destination address (e.g. packets requiring mirroring based on who sent the data or whom the data is being sent to) and packets requiring Network Address Translation (NAT). Any router administration protocol based data packet is treated as processing type data as well. Those skilled in the art will appreciate that the above list is intended to be exemplary and not exhaustive. So long as the data is not being simply forwarded along, it can be treated as processing data. These types of data can be handled differently to provide both datapath efficiencies in inter-logical router routing and network visibility for the logical routers and paths between them.

To provide datapath efficiencies, a degree of route leaking can be performed so that a logical router receiving data packets can forward the data packets directly to the appropriate egress port. However, prior to routing, the destination address of the data packet is preferably examined to determine if the data packet is forwarding data or processing data. If the packet is forwarding data, an efficient data path is utilized, while if the packet is processing data, the packet is passed between the logical routers over the virtual links to provide visibility to outside components.

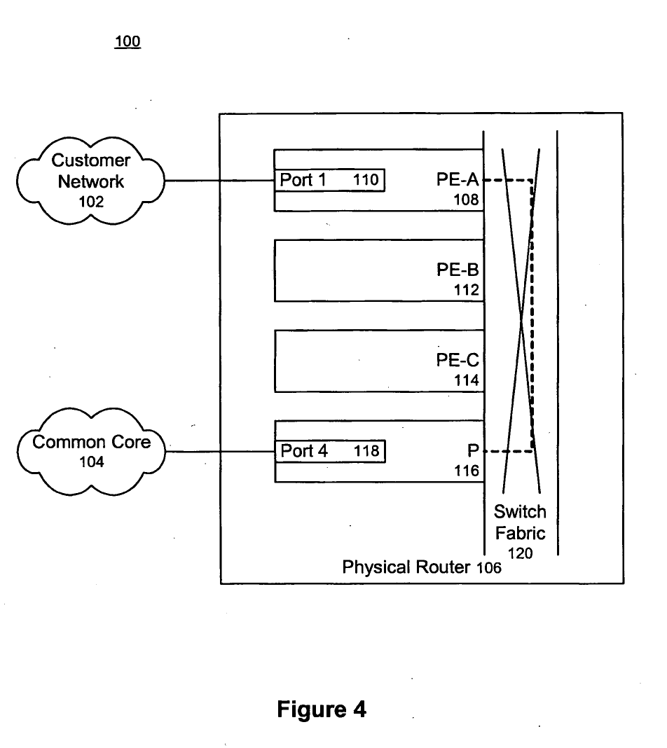

FIG. 4 illustrates an embodiment of such a router. Network 100 includes a customer network 102 and a common core network 104. These networks are connected to each other by a network visible virtual link enabled router 106. Router 106 includes logical routers PE-A 108, PE-B 112, PE-C 114, and P 116. Although all logical routers are typically connected to networks, these elements, and the ports of routers PE-B 112 and PE-C 114 have been omitted for the sake of clarity. Logical routers PE-A 108 and P 116 are connected to customer network 102 and common core 104 by Port 1 110 and Port 4 118 respectively. All the logical routers are internal to physical router 106 and are connected to the switch fabric 120, which can be an instance of a backplane connecting a series of routing cards in router 106.

As noted by the broken line, PE-A 108 and P 116 can form a virtual link to each other through the switch fabric. As opposed to the hairpin connected systems of the prior art, which would have the cards externally connected, and would require two passes of a packet through the switch fabric, a virtual link between the routers can be used to allow a packet to pass through the switch fabric in a single pass. This results in better throughput and a lower packet latency.

In order to provide a single pass through the switch fabric for a routed packet, the logical router receiving data (PE-A 108 receiving data from customer network 102 destined for common core 104) is provided that ability to access the egress ports of other routers (in this example port 4 118 of router P 116). To provide the widest applicability, standard routing protocols can be used over the virtual link forged through the switch fabric to allow the egress interface information to be exchanged. As a result, any of Border Gateway Protocol (BGP), Routing Information Protocol (RIP), Open Shortest Path First (OSPF) and ISIS can be used to control the routing information provided by each of the logical routers to the other logical routers over virtual links. One skilled in the art will appreciate that other routing control protocols can also be used without departing from the scope of the invention.

The use of a standard routing protocol across the virtual link allows seamless routing interconnectivity between the routing engines and provides a simplified OAM. If a logical router is not supposed to be provided with routing access to a certain set of network addresses, the transfer of this routing information can be prevented by the application of the desired policies using the administration functions of the above-mentioned standard protocols. As a result, the administration policies to prevent the cross over of addresses corresponding to certain services can easily be enforced. This addresses some of the operational concerns posed by route leaking techniques, which are often vendor specific and require administration policies to be modified depending on the hardware platform used.

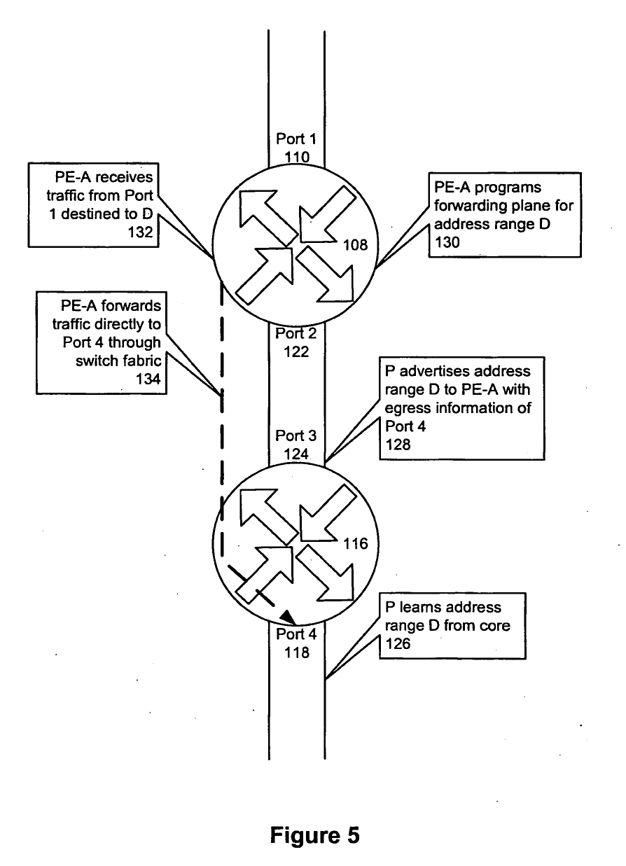

FIG. 5 illustrates the functioning of the router to allow direct forwarding of received packets. As illustrated logical router PE-A 108 is connected to Port 1 110, while logical router P 116 is connected to Port 4 118. The two logical routers are connected to each other by a virtual link between virtual port 2 122 and virtual port 3 124. The virtual link preferably makes use of standard routing protocols as discussed above. Logical router P 116 receives information in step 126 over port 4 118 about the existence of a range of network addresses D from the core network. At this point, logical router P 116 knows that to reach an address in range D, the packet should be placed on port 4 118. Logical router P 116 creates a virtual link through the switch fabric between port 3 124 and port 2 122, and advertises the existence of address range D to PE-A 108 in step 128 along with the accessibility of address range D through port 4 118. Having learned of the existence of address range D in step 128, PE-A updates its forwarding plane in step 130 so that it will know that all data packets received that are destined for an address in range D should be placed on port 4 118. In step 132 PE-A receives traffic over port 1 110 that is destined-for an address in range D. This data requires no router processing. PE-A directly forwards the traffic to port 4 118 through the switching fabric in step 134 after performing the appropriate data inspection and administrative functions. As the data packet has effectively crossed two different logical elements (PE-A 108 and P 116), the TTL value of the data packet is decremented by two. This maintains the appearance to outside network elements that there are distinct routers in the overall data path.

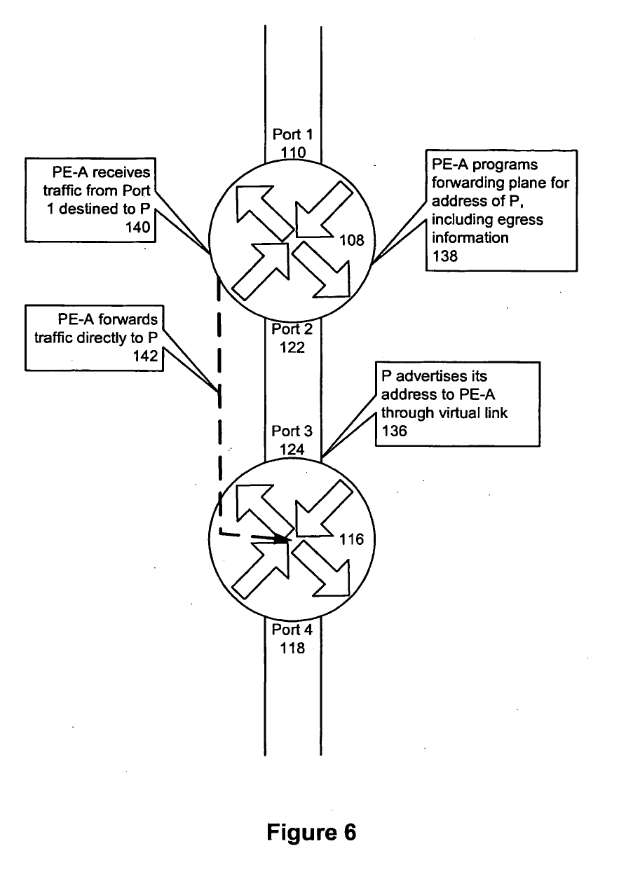

One skilled in the art will appreciate that this reduces the data path to the most efficient path, much as route leaking did. However, in contrast to route leaking, the full data path can be visible to the external networks. To gain visibility and to perform OAM functions, processing data is transmitted between logical routers over virtual links. This gives the outward appearance of the expected network topology. Processing data typically includes routing protocol packets, and OAM traffic such as telnet, file transfer protocol (ftp), ping and trace route. FIG. 6 illustrates how this data is handled.

Logical router P 116 creates a virtual link between itself and logical router PE-A 108 through Port 3 124 and Port 2 122. Over the virtual link in step 136, P 116 advertises its local address to PE-A with egress information corresponding to the virtual link. In step 128, PE-A learns the local address of P 116, and stores that address, along with the appropriate egress information corresponding to the virtual link, in the forwarding plane. In step 140, PE-A 108 receives a data packet on Port 1 110. This packet is destined for an address corresponding to logical router P 116 and is thus processing data. The egress information is obtained from the forwarding plane and, in step 142, PE-A 108 forwards the traffic to P 116 through the switch fabric and decrements the TTL value. The datapath terminates at logical router P.

One skilled in the art will appreciate that the above-described routines require slightly different handling of data packets based on whether the data packet is forwarding data or processing data. When the data is tandem data, logical router A performs all the routing functions, and forwards the data to the corresponding egress port after decrementing the TTL value accordingly. When the data is processing data, a virtual link is created to the terminating destination and the data is forwarded to the destination after appropriately decrementing the TTL value. By handling the routing and TTL decrementing differently, an efficient datapath is obtained, and external visibility of the logical links between the logical routers is obtained.

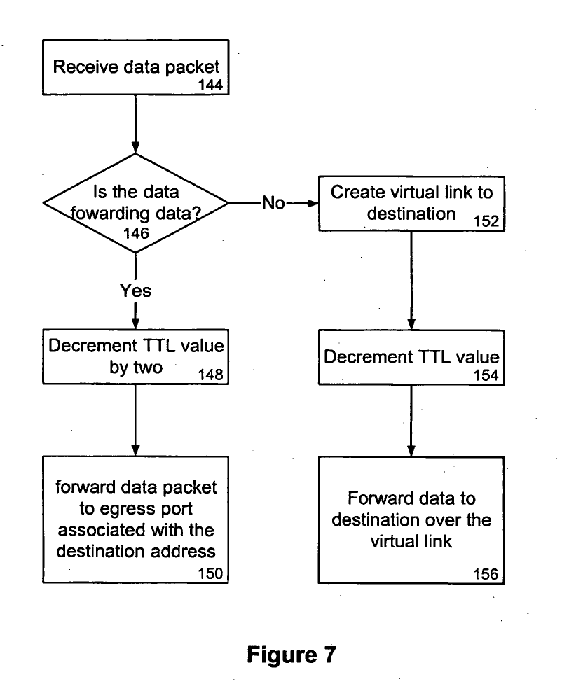

FIG. 7 is a flowchart illustrating a method of the routing packets through the logical routers that provides virtual link visibility. After receiving routing information for both external address ranges and other logical routers in the physical router, a logical router, such as PE-A 108, receives a data packet in step 144. In step 146 a determination of whether or not the packet is forwarding data is made. If the data is not forwarding data it is considered to be processing data. If the data packet is considered to be forwarding data, the process continues to step 148 where the TTL value is decremented twice, and then to step 150 where the data packet is forwarded directly to the egress port associated with the data packet in the forwarding plane of the logical router. In being forwarded to the egress port directly, the data packet will singly traverse the switch fabric of the router. If, in step 146, it is determined that the data is not forwarding data, a virtual link to the destination logical router is created in step 152. In step 154, the TTL value of the data packet is decremented, and in step 156 the data packet is forwarded over the virtual link to the destination logical router.

One skilled in the art will appreciate that the order of the steps can be varied, and certain steps can be broken into component steps, or collapsed into combined steps, without departing from the scope of the present invention. As a series of non-limiting examples, instead of determining if the data is forwarding data, a determination of whether or not the data is processing can be made, with the appropriate reversal of the decision tree; in place of double decrementing the TTL value, the TTL value can be decremented by 1 upon receipt of the data packet, and then, only if the data is determined to be bypassing a logical router, the TTL value can be decremented again. In other embodiments, it is conceivable that a data packet may be received on a logical edge router, and be destined for an address available through another logical edge router. The two edge routers may be logically connected only through a logical core router. If the routing table of the first logically router is appropriately set up, the data packet can be forwarded directly to the appropriate egress port, and the TTL value would then be decremented by 3 to reflect that 3 routing nodes have been traversed. Processing data received in this fashion for another logical edge router could be forwarded directly to the logical edge router through a virtual link with the TTL value decremented by 2. In other embodiments, due to the rarity of such an event, access to the egress ports of another logical router, or to the other logical router itself, may be provided only through the creation of a virtual link to the virtual core router, which will then create a virtual link to the other virtual edge router.

To make links between logical routers visible, the router appropriately modifies the packet, or data associated with the packet, to indicate that there are virtual links. Above-described examples indicated that the TTL value is multiply decremented to show route traversal, but those skilled in the art will appreciate that other route visibility mechanisms, including providing costs associated with traversal of virtual links and route peering can be implemented in a similar manner using standard routing protocols upon determining that a received data packet is a processing or forwarding type data packet. This can entail modifying the header or payload of a packet, or modifying any other information associated with a data packet to indicate to OAM tools that the virtual links between the logical routers can be traversed. By handling forwarding type packets and processing type packets differently, the router is able to determine which data packets should be immediately forwarded to an egress port (with the TTL value appropriately decremented to show traversal of the appropriate number of nodes) and which data packets should be passed through virtual links between logical routers so that at least one of the logical routers can perform administrative functions on the packet to provide the external visibility of the inter-logical router links. This allows the routing protocols to treat the virtual links spatially, leading to them acting like true links from a network planning perspective, and allows TTL handling, cost assignment and peerings to be performed without changing the OAM handling.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of routing a data packet, having header and payload information, received at a physical router having a plurality of logical routers, the method comprising:
receiving the data packet at a first logical router; and
directly routing the data packet to an egress port and modifying the packet to indicate traversal of a logical router network, if the packet is a forwarding type data packet.

2. The method of claim 1 including the steps of:
determining a packet type associated with the data packet to be one of a forwarding type or a processing type prior to directly routing the data packet to an egress port; and
forwarding the data packet to a second logical router over a virtual link and modifying the packet to indicate the traversal of the virtual link if the packet is a processing type data packet.

3. The method of claim 2 where in the step of determining the packet type includes examining at least one of a packet destination address and a packet protocol.

4. The method of claim 2 wherein the step of directly routing the packet to an egress port and modifying the packet includes modifying the header of the data packet to indicate traversal of the logical router network.

5. The method of claim 2 wherein the step of forwarding the data packet to a second logical router over a virtual link and modifying the packet includes modifying the header of the data packet to indicate traversal of the virtual link.

6. The method of claim 2 wherein the step of forwarding the data packet to a second logical router over a virtual link and modifying the packet includes modifying the payload of the data packet to indicate properties associated with the virtual link.

7. The method of claim 4 wherein the step of modifying the header information includes decrementing a time to live value in accordance with a destination address associated with the data packet.

8. The method of claim 4 wherein the step of directly routing the data packet to an egress port and modifying the header information includes decrementing a time to live value in the header by two.

9. The method of claim 3 wherein the step of forwarding the data packet to a second logical router and modifying the header information includes decrementing a time to live value in the header by one.

10. The method of claim 2 wherein the step of routing the data packet to an egress port includes selecting one of a plurality of ports in accordance with a destination address associated with the data packet.

11. The method of claim 2 further including receiving, at the first logical router, an address range associated with an egress port over a virtual link from the second logical router in advance of the step of receiving the data packet.

12. The method of claim 11 wherein the step of receiving the address range includes updating a local routing table in accordance with the received address range and associated egress port.

13. A router for receiving a data packet on at least one of a plurality of ports and for forwarding the received data packet to another destination on another of the plurality of ports in accordance with a destination address associated with the data packet, the router comprising:
first and second logical routers connected to a switching fabric, each logical router associated with at least one port;
the first logical router for receiving a data packet arriving on a first of the plurality of ports, for determining whether the received data packet is a forwarding type data packet or a processing type data packet, and for routing the data packet to one of the second logical router and one of the plurality of ports not associated with the first logical router in accordance with the determined packet type; and
the second logical router for receiving, on its at least one associated port, routing information for a range of network addresses, for creating a virtual link to the first logical router through the switching fabric, and for transmitting the routing information for the range of network addresses associated with the at least one associated port to the first logical router over the virtual link.

14. The router of claim 13 wherein the first logical router includes a routing table updater for updating a locally stored routing table with information provided by the second logical router over the virtual link.

15. The router of claim 13 wherein the first logical router includes means to determine the data packet type based on whether the packet requires simple forwarding or requires router processing.

16. The router of claim 13 wherein the first logical router includes header modification means for modifying a head associated with the data packet, prior to routing, to indicate traversal of a routing network.

17. The router of claim 16 wherein the header modification means includes means to decrement a time to live value in the header in accordance with a destination address associated with the data packet.

18. The router of claim 17 wherein the header modification means includes means to decrement the time to live value decrements the value by 1 if the data packet is a processing type data packet.

19. The router of claim 17 wherein the header modification means includes to decrement the time to live value decrements the value by 2 if the data packet is a forwarding type data packet.

20. A physical router having a first logical router for receiving a data packet, the first logical router comprising:
a packet type determination means for determining whether the data packet is a processing type data packet or a forwarding type data packet;
a virtual link creation means for creating a virtual link between the first logical router and a second logical router when the received data packet is determined to be a processing type data packet;
an egress port access means for creating a link between the first logical router and an egress port not associated with the logical router when the received data packet is determined to be a forwarding type data packet; and
a data packet forwarder for receiving the data packet type from the packet type determination means, and for instructing either the virtual link creation means or the egress port access means to create a link based on the received data packet type and a destination address associated with the data packet, for decrementing a time to live value associated with the data packet in accordance with the received data packet type, and for forwarding the received data packet to a destination over the created link.

21. The router of claim 20 wherein the logical router is hosted by a processor internal to the physical router on a dedicated service card having at least one data port associated with the hosted logical router.
